(19) United States
(12) Patent Application Publication
(10) Pub. No.: US 2007/0174910 A1
(43) Pub. Date: Jul. 26, 2007

(54) COMPUTER MEMORY SECURITY PLATFORM

(76) Inventors: Frederick John Zachman, Woodbury, MN (US); William E. Jacobus, Woodbury, MN (US)

Correspondence Address: FAEGRE & BENSON LLP;PATENT DOCKETING, 2200 WELLS FARGO CENTER, 90 SOUTH SEVENTH STREET, MINNEAPOLIS, MN, 55402-3901, US

(21) Appl. No.: 11/609,783

(22) Filed: Dec. 12, 2006

Related U.S. Application Data
(60) Provisional application No. 60/750,007, filed on Dec. 13, 2005.

(51) Int. Cl. G06F 12/14

(52) U.S. Cl. 726/18

(57) ABSTRACT

A computer memory security platform (“MSP”) includes computer system memory, circuitry, control drivers and on-board security control apparatus capable of both interacting with, and ensuring protection of, user-level application programs and kernel-mode drivers of the associated computer operating system or hypervisor executive. Through the use of an in-band control protocol, an out-of-band management protocol, and a side-band memory processing protocol, the MSP hosts a series of related control components and dynamically-loaded, hardware-resident security modules to provide executive system and application security. Special circuitry within the MSP monitors the on-board system memory to help ensure application isolation and overall executive system integrity. Depending upon configuration, the security memory platform can reside inside a standard computer form factor, or be deployed outside as a stand-alone device to provide same functionality in a simultaneous virtualization capacity for numerous computer systems.

This application claims the benefit of U.S. provisional application Ser. No. 60/750,007, filed Dec. 13, 2005, the entire content of which is incorporated herein by reference.

### TECHNICAL FIELD

In general, the invention relates to computer systems, and, in particular, to the security of computer systems.

### BACKGROUND

All specific and general-purpose computers are based upon a primary processing unit(s) or processor(s) and some form of memory module or subsystem. The processors are designed to load the steps or instructions of a computer program and execute those instructions against applicable data to perform the task in question.

The processor is controlled by a hypervisor or operating system (“OS”), which is a general or specific executive program (“Exec”), usually providing preemptive multitasking features, capable of running many systems and application programs concurrently.

Application programs, and the Exec itself, are constructed of numerous programmatic components that can be dynamically loaded as directed by the Exec or the application in question. Some of these programmatic components run in user space and others run in Exec space (“Kernel Mode”). The Exec uses Kernel Mode to provide the general computing platform—either singularly, through the single instance of the OS, or in combination through the hypervisor and associated subordinately-hosted OS platforms. In conjunction with the hardware processor, which may offer hypervisory or multi-platform support directly, and the optional hypervisor, the OS presents a set of programmatic interfaces and device hardware abstractions that allow software engineers to write useful computer programs.

Many of these Kernel Mode components are a part of the Exec proper, while others are device drivers used to control specific hardware components of the computer. Regardless, all Kernel Mode components operate at the same level. It does not matter if the Kernel Mode component was an original part of the Exec, or if it was an after-market component provided by a third-party vendor; regardless, each has the same privilege level as the other.

The programmatic modules are generally dynamically loadable. As new programmatic modules can be added dynamically; however, it is relatively easy for intruders to introduce malicious components into the system.

Current security measures generally make use of signature-based mechanisms in order to detect such anomalous or rogue software on a system, and some offerings are now looking at statistical or behavioral based detections.

One shortcoming of many current computer security solutions is that the efforts focus on techniques that cannot ensure that the security solution remains in operation on the computer or digital device. Any proposed security software is installed on the computer along with the Exec and all the other Kernel Mode components. As such, the security software is subjected to the same hostile environment that caused the original security problem.

If an intruder wishes to commandeer a system, all they have to do is install a rogue programmatic component (virus, spyware, trojan or rootkit) on the computer. With such a component, the intruder could completely disable existing security mechanisms. Additionally, using certain programmatic techniques, an intruder could gain access to all memory, files and data on the system and remain completely hidden in their activities.

### SUMMARY

In general, embodiments of the invention constitute a Memory-Security Platform (“MSP”) to ensure rogue programmatic code segments do not take control of specific software applications or data within the computer, phone or other digital appliance, and to provide an overall security platform for both current and future security algorithms. Embodiments may be viewed as a hardware-managed approach to guarding the memory subsystem with communication from the core task, register, context and virtual paging information of the CPU, Northbridge and hypervisor or executive operating system(s).

In one example, a computing system comprises a processor, one or more memory modules, a hardware-based security controller positioned between the processor and the memory modules, and a software isolation (ISO) module that is a kernel-level software component that monitors memory operations issued by software application executed by the processor. The ISO module captures context and control information from the memory operations and communicates the information to the security controller. The security controller applies one or more security operations to memory operations between the processor and the memory modules to ensure that the software applications executed by the processor are secure.

In another example, a method comprises executing a software module within a computing system to intercept a request from a software application to access data stored in a hardware memory module of the computing system. The method also comprises relaying information from the software module to a hardware-based security integrated circuit embedded within a memory system of the computing system. The information comprises context information for the software application. The security integrated circuit is positioned to access a memory bus between a memory controller and a module. In addition, the method comprises, subsequent to relaying the information, monitoring a memory access request between a processor and the memory module with the hardware-based security integrated circuit. The method also includes determining within the hardware security integrated circuit, based on the context information, whether the monitored memory access request constitutes a security threat. In addition, the method comprises performing the memory access request when it is determined that the request does not constitute a security threat.

In another example, the MSP is an integrated high-speed memory module and security platform. In others, the MSP may, for example, manifest itself within a Northbridge memory controller or CPU directly. Application and security software programmers are able to develop software programs that interact with the MSP to ensure secure operation. For example, application programmers can request their program run in isolated memory space to ensure that sensitive data is protected from unauthorized access, even from the Exec itself. If a program or component outside of the application tries to access application memory, the MSP blocks the operation.

Most computer systems and digital appliances employ the same general architecture where a processor communicates with a logic block that is able to in-turn properly communicate to a memory subsystem. However, there is no mechanism in current computer systems that would communicate critical operational information to a hardware security mechanism such that the memory subsystem can be effectively protected.

One embodiment of the MSP itself provides a real-time security platform and memory subsystem of current and future computational systems. Because of its unique ability to offer search, filtering, monitoring and real-time protection without burden on CPU or system buses, the MSP offers fundamental security features and operations needed for protecting digital or computing systems, their operational programs and the data they manipulate.

A practical example of the MSP resides in its ability to host and protect numerous security algorithms/functionality operating at wire speed, while simultaneously offering system and application programmers the ability to uniquely protect and control access to their specific computer programs' memory. In essence, the MSP works to help isolate the operations of individual computer logic within a multi-tasking, multi-process general-purpose computer or specific computing device, thereby increasing the protection of computer operations and data security.

In like manner, security designers can create solutions that interact with the MSP security device for the purposes of applying their security-protection logic directly towards the memory subsystem itself. Such protection logic activates in the device's on-board control circuitry to provide high-speed protection without the need to block access and control of the system/memory bus.

In one aspect, the invention relates to the creation of a more secure computer, phone, digital appliance or other device operating according to the processor-memory paradigm. The invention, by providing a special computer memory security platform, delivers protected, real-time security algorithm hosting, dynamic credentialing and encryption, application operation isolation functionality, hypervisor or operating system driver and system memory protection and hosted security logic operations from within the memory subsystem itself.

In some embodiments, the MSP software and hardware institute special operational elements that provide for more secure operation of the hypervisor or executive program, kernel components, application programs, disk files and memory access. For example, various example embodiments of the MSP provide one or more of the following features.

In one example, the MSP may interact in-band (within the standard bus mechanism) with computer executive program, operating system modules and computer applications to provide security and application isolation features, or ultimately as a CPU logic component for the same purposes.

In another example, the MSP may protect data, application, security and executive software operations through side-band (within a new invention-to-memory mechanism) memory processing, monitoring and access-protection activities.

In another example, the MSP may provide out-of-band (outside of the standard bus mechanism) security management operations using a mobile security component and an existing communication bus, or a new management bus (“SafeBus”).

In another example, the MSP may safely create, store and administer standard and dynamic credential, encryption, and hash functions, along with their associated control keys used in computer and application security operations.

In another example, the MSP may offer audit and other integrity-check mechanisms to increase protection of executive system primitives, drivers and programmatic interfaces.

In another example embodiment, the MSP may provide a hardware-protected general security platform for various third party security developers.

In another example, the MSP may use in-band signaling between the MSP control software and hardware device. This feature is used to maintain the existing footprint and form factor of current day computer systems.

In another example, the MSP may offer hardware-backed protection of software modules to help ensure that selected critical software modules are not injected with rogue software, and remain in operation, thereby providing their designated operational or security functionality.

In another example, the MSP may offer side-band security operations in parallel so to avoid latency or contention problems that may interfere with CPU or direct memory access (DMA) operations of the host system.

In another example, the MSP may provide security and encryption key storage that provides access to secure key storage for use in encryption and security operations that are critical to protecting access and user data.

In another example, the MSP may provide dynamic credential generation. This feature establishes a protected interface between the MSP device and control software to help prevent against unauthorized operations. Additionally, the dynamic credentialing operations provide application security when functionally and/or data is extended through the application program interface to outside users.

In another example, the MSP may utilize a watchdog control mechanism. This feature helps ensure that critical control software is present and operational on a regular basis. Failure of the feature ensures that memory is blocked from all future access.

In another example, the MSP may utilize a tracer feature between control software elements. This feature helps audit the system and ensure the integrity of executive program operations and application programming interfaces used by general and specific programs.

In another example, the MSP may provide blades or on-board device computational modules. This feature provides executive, application and security applications the opportunity to deliver specific computational logic to the MSP device for the purposes of memory search, filtering, monitoring or real-time protection.

In another example, the MSP may utilize an isolation module (ISO Module) for command-and-control operations. This feature helps to protect executive, application and security programs and offers access to the device hardware via in-band communications. This feature also provides context, memory-map and executive operation information used in generic and specific security features.

In another example, the MSP may provide both in-system (computer, smart phone) and external-system deployment. This feature allows use with present day systems or provides for solutions in scenarios such as data centers where operational management dictates centralized management.

In another example, the MSP may offer the ability to link individual MSP devices (as used in multiple computer systems). This feature provides for applying search, filtering, monitoring and real-time protection across multiple computer systems for the purpose of integrated, centralized operation and management.

In another example, the MSP may utilize a unique security primer that initializes the MSP such that key operational components of the device act to protect one another against outside intrusion. This feature provides a level of assurance currently unavailable in security solutions.

In another example, the MSP may provide memory context information regarding memory I/O operations. This feature helps provide determination of memory access intent needed to provide advanced security.

In another example, the MSP may provide self-check functionality. This feature helps to ensure the integrity of the MSP and the executive, application and security programs on the computer system.

In another example, the MSP may provide memory I/O capture and emulation. This feature provides state and memory access playback feature to facilitate training, development and research.

In another example, the MSP may provide compliance logging and enforcement. This feature helps with monitoring or blocking of operations as mandated by various regulations and laws.

In another example, the MSP may provide integrated command-and-control management. The feature offers system users the ability to securely add application and system software to the list of protected modules. Users can monitor MSP activity and escalate security functionality based upon need or scenario. A key component of this offering is the out-of-band security control feature offered by MSP device.

In another example, the MSP may utilize out-of-band security initialization. This feature configures and transmits initialization information to and from MSP device to outside of host system in order to assure secure initialization of the MSP.

In another example, the MSP may utilize localized control and configuration without migratory key requirement. This feature provides the security and functional offerings on a particular computer system without the need to deploy certificates or other security measures across platforms. This removes the cost and complication of global certificate/key management, and allows the various development/management personnel to work with the MSP on a localized or global level as the need dictate.

In another example, the MSP may utilize a mechanism to check and detect memory operations that are executed on behalf of an unregistered task or process. This feature helps to illuminate unauthorized tasks or processes that are common to spyware and/or rootkits.

In another example, the MSP may provide a secure installation mechanism for the ISO Module that is protected by the MSP Security Controller 7. The device then footprints the ISO Module and ensures correct allocation of the Master Credential (protected command-and-control token) and dynamic WakeUp control (specialty triggering command-and-control token).

In this manner, the MSP may provide one or more benefits and advantages over both current memory modules, and available security solutions.

### BRIEF DESCRIPTION OF THE DRAWINGS

FIG. 1 is a block diagram illustrating high-level components of a computer system.

FIG. 2 is a block diagram illustrating a computer system with an exemplary computer Memory Security Platform (MSP), in accordance with the invention.

FIG. 3 is a block diagram illustrating an exemplary MSP Security Controller applying monitor and filter operations on a memory I/O request as the memory I/O request flows to and from the memory module.

FIG. 4 is a block diagram illustrating an exemplary MSP Security Controller placed upon a standard DIMM memory stick.

FIG. 5 is a block diagram illustrating an exemplary embodiment of the MSP.

FIG. 6 is a block diagram illustrating a second exemplary embodiment of the MSP.

FIG. 7 is a block diagram illustrating an exemplary Isolation Module (ISO Module) intercepting process context and memory page-fault invocations and communicating that information to the MSP Security Controller via the standard memory bus mechanism.

FIG. 8 is a block diagram that depicts a currently running task within the computer system.

FIG. 9 is a block diagram illustrating an exemplary operational flow of a computer system as it attempts to run an active process.

FIG. 10 is a block diagram illustrating the presence of the ISO Module intercepting process context and memory page-fault invocations. FIG. 10 also shows the Watchdog timer triggering the ISO Module to invoke security features.

FIG. 11 is a block diagram illustrating an exemplary embodiment of a memory security platform hosting programmable security blades.

FIG. 12 is a block diagram illustrating an exemplary control structure that allows a standard memory bus mechanism to provide a command-and-control structure. The figure also illustrates an exemplary transmission of security state information from the MSP Security Controller to Security Control Program(s)—both local and remote/detached.

FIG. 13 is a block diagram illustrating the cooperative security mechanism used to ensure the safety of the various computer components.

FIG. 14 depicts a sample MSP Command Packet as it traverses the standard bus from the ISO Module to memory.

FIG. 15 is a block diagram illustrating an exemplary dynamic mechanism to generate, disseminate, store and control access to important access credentials and encryption key control strings.

FIG. 16 is a block diagram illustrating an exemplary system that uses a method of cooperating-process initialization (“CP Initialization”) to initialize itself and the host computer system in which the system is installed.

FIG. 17 is a block diagram illustrating an exemplary integrated command-and-control management mechanism. The figure also shows a registration and control of registered MSP applications partaking of MSP security.

FIG. 18 is a block diagram illustrating an exemplary embodiment of a MSP Security Controller in a form that suits a “data center” scenario.

### DETAILED DESCRIPTION

The Memory Security Platform (MSP) described herein is a security device consisting of circuitry, software and/or firmware that provides a protective platform for normal computer systems or digital devices, and their associated security operations. As described herein, one security mechanism provided by the MSP is that of inline, real-time supervisor and security platform.

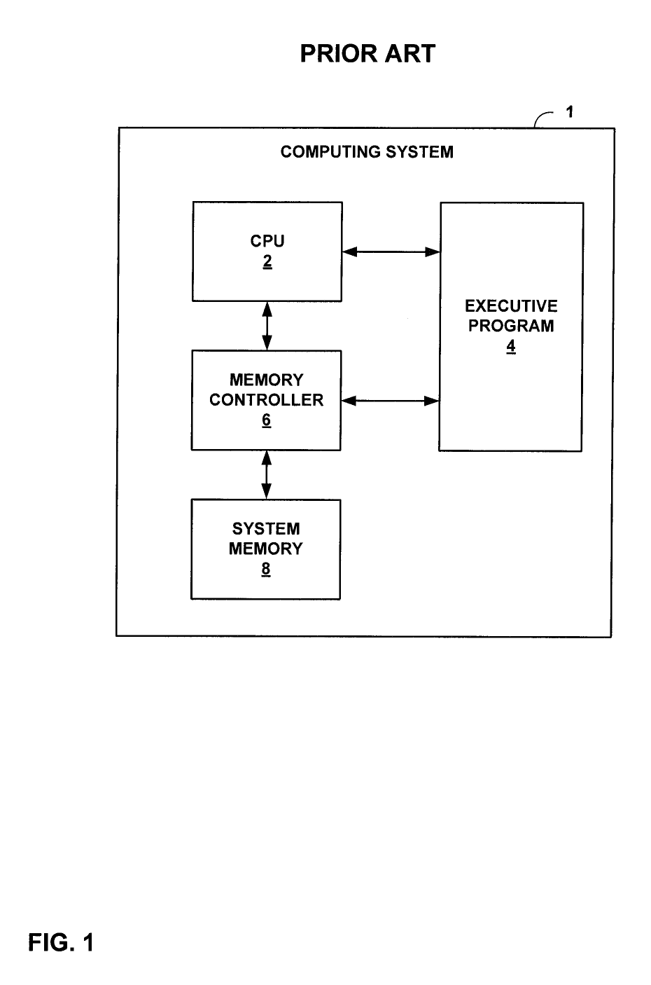

FIG. 1 is a block diagram illustrating an exemplary computational architecture in which the MSP operates. For purposes of example, the principles of the invention will be described with respect to a personal computer (PC) computing system 1 having a computational memory pathway that relies on three major components for operation: a central processing unit (CPU) 2, a memory controller 6, and a system memory (e.g., “RAM”) 8. System memory 8 may include one or more single in-line memory modules (SIMM), dual in-line memory modules (DIMM), double data rate synchronized dynamic random access memory modules (DDR), double-data-rate two synchronous dynamic random access memory modules (DDR2) or other types of memory modules. Many different types of memory are commodity memory technology wrapped into a pluggable, hardware module. The next generation PC system may employ the three major blocks. However, a new serial communication structure may be used between the memory controller and memory elements. As such, future systems could actually do away with the memory controller entirely and allow the processor to talk directly to the memory sub system. Executive Program 4, which may be a hypervisor or operating system (“OS”), usually provides preemptive multitasking features, capable of running many systems and application programs concurrently.

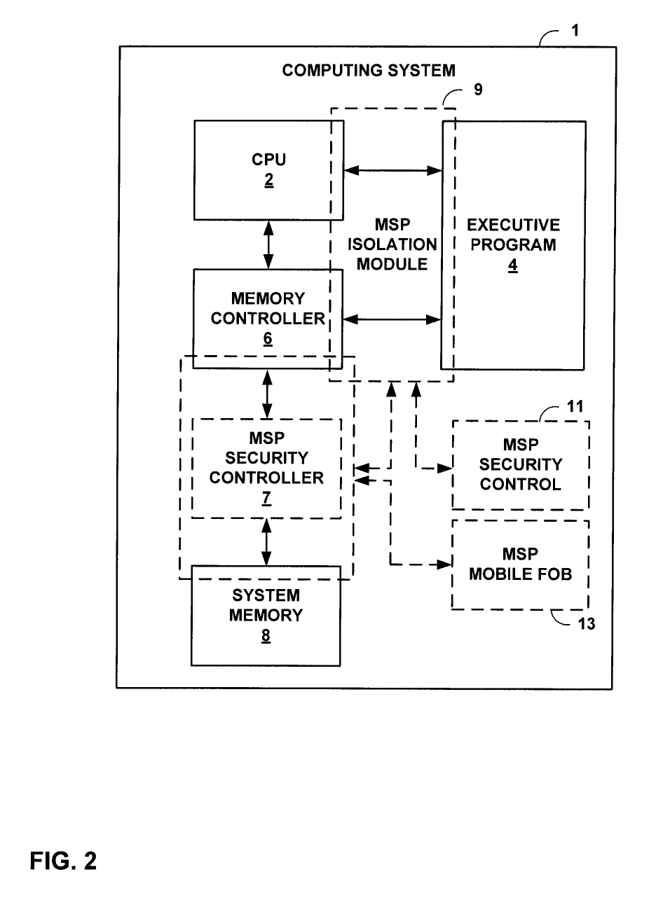

FIG. 2 is a block diagram illustrating an exemplary computational architecture 1 with four associated MSP components shown in context. As described in further detail below, an example MSP implementation may contain for components: MSP Security Controller 7, Isolation (ISO) Module 9, MSP Mobile fob 13, and an MSP Security Control Program 11.

For purposes of the example, the exemplary ISO Module 9 and MSP Security Controller 7 are shown bridging the gap between the existing components of the computational architecture. ISO Module 9 may take the form of a kernel-level software component that monitors memory operations issued by Executive Program 4 or other software applications executed by CPU 2. ISO module 9 provides logic that may be resident in Executive Program 4, as well logic that may be resident within CPU 2 or memory controller 4. Likewise, MSP Security Controller 7 is a hardware-based security control that is positioned between CPU 2 and system memory 8. MSP Security Controller 7 provides logic that may reside in specific hardware and circuitry, or become integrated directly with existing digital device or computer system components such as circuitry of CPU 2, memory controller 4, or memory modules of system memory 8.

MSP Security Controller 7 acts as a security checkpoint for all operations across the memory subsystem of computing system 1. The components of the MSP cooperate to provide a mechanism to protect data, Executive Program 4 and application programmatic elements from attack.

The MSP described herein utilizes ISO Module 9. An exemplary ISO Module 9 is a special executive or OS kernel component that monitors, among other things, the active task and memory operations of the active task and communicates the information regarding the active task and memory operations of the active task to MSP Security Controller 7. For example, ISO Module 9 may capture or otherwise obtain important context and control information and communicate the captured information to MSP Security Controller 7. MSP Security Controller 7 monitors, processes and protects the memory subsystem and memory I/O operations that flow between CPU 2 and the actual memory chips of system memory 8. MSP Security Controller 7 may ensure that the software components of the invention, as well as the Executive Program 4, are operational and secure.

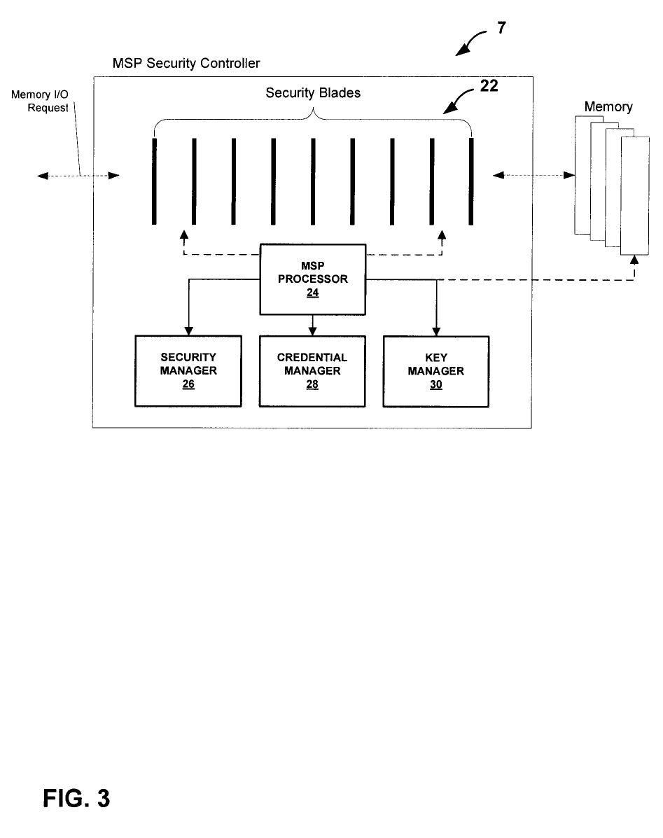

FIG. 3 is a high-level block diagram illustrating an exemplary MSP Security Controller 7 shown intercepting memory I/O requests as the memory I/O requests flow between CPU 2 and a memory module within system memory 8. The example shows an embodiment in which MSP Security Controller 7 includes a plurality of Security Blades 22 that provide security operations on the memory I/O request as the request flows from the CPU 2 to the memory module (and back), as well as security operations directly on memory itself, independent of the individual memory I/O request.

As a memory I/O request flows across the plurality of Security Blades 22 on a path of the memory I/O request to the memory, MSP processor 24 reviews, monitors, checks, transforms or blocks the memory I/O request at each stage of the stack of Security Blades 22 as directed by security settings. In other words, MSP processor 24 uses Security Blades 22 to determine whether the memory I/O request constitutes a security threat. If MSP processor 24 determines that the memory I/O request does not constitute a security threat, MSP processor 24 allows the memory I/O request to be performed. Security Blades 22 are shown inline for simplicity of illustration, but the MSP Security Controller 7 may process the Blade operations serially or in parallel as security conditions warrant.

Embodiments of the MSP utilize a multi-function application-specific integrated circuit (ASIC) kernel and control mechanism, i.e., the MSP Security Controller 7, physically embedded within the memory module itself to monitor and control access to system memory 8. This feature provides high-speed security functionality without diminishing overall system throughput or adding to CPU or bus contention.

MSP Security Controller 7 has circuitry that accepts the memory I/O request in real-time, and then imparts various security/monitoring operations on the memory I/O request as it continues its flow to and from the memory chips.

The MSP contains several additional security features by nature of its self-contained platform structure. The MSP Security Controller 7, for example, may have storage, computational and logic components that provide security operations for the host system, i.e., computing system 1.

FIG. 3 illustrates several of the exemplary high-level logical security components within the MSP Security Controller 7 that interact with a MSP Processor 24: Security Blades 22, Security Manager 26, Credential Manager 28, Key Manager 30.

On-board MSP processor 24 controls and coordinates security components 22, 26, 28 and 30 to deliver security features. One construct of the MSP is that these security features are provided to the base computer or digital system (i.e., computing system 1) because the MSP Security Controller 7 is embedded within the host system, yet the functionality is protected from rogue software components because the MSP Security Controller 7 control mechanisms are not directly accessible from the host system. For example, in some embodiments, at least in part, the MSP Security Controller 7 may be embedded within the memory module(s) of system memory 8. In other embodiments, the MSP Security Controller 7 may be embedded within the host memory controller 6.

Security Blades 22 are logical security processing elements used to administer security detection, monitoring and policy operations on the memory I/O cycle or against the memory elements themselves. Security Blades 22 may implement base security logic or may use configuration information downloaded and installed within MSP Security Controller 7 from third parties. The dynamically configurable information may control limited aspects of the operation of Security Blades 22 but do not constitute executable code. Because the dynamic configuration information does not constitute executable code, the configuration information may not constitute an active virus or rootkit.

Security Manager 26 is a base logical component of MSP Security Controller 7, and represents the main component that interacts with and provides an interface to ISO Module 9.

Credential Manager 28 is the logical security, storage and management element of MSP Security Controller 7 that governs standard and dynamic credential creation and control.

Key Manager 30 is a logical security, storage and management element of MSP Security Controller 7 that governs encryption, key control and associated access.

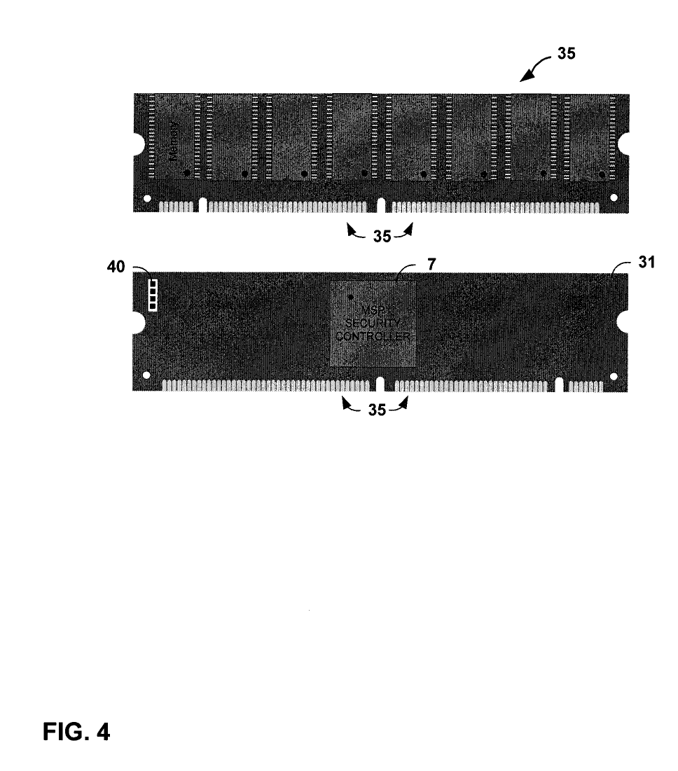

FIG. 4 is a schematic diagram illustrating an exemplary embodiment of MSP Security Controller 7 embodied as an onboard memory security platform 31. In this embodiment, onboard memory security platform 31 has a size and an electrical interface 35 that conforms to a “pluggable” memory stick standard that may be inserted within a standard memory slot of computing system 1.

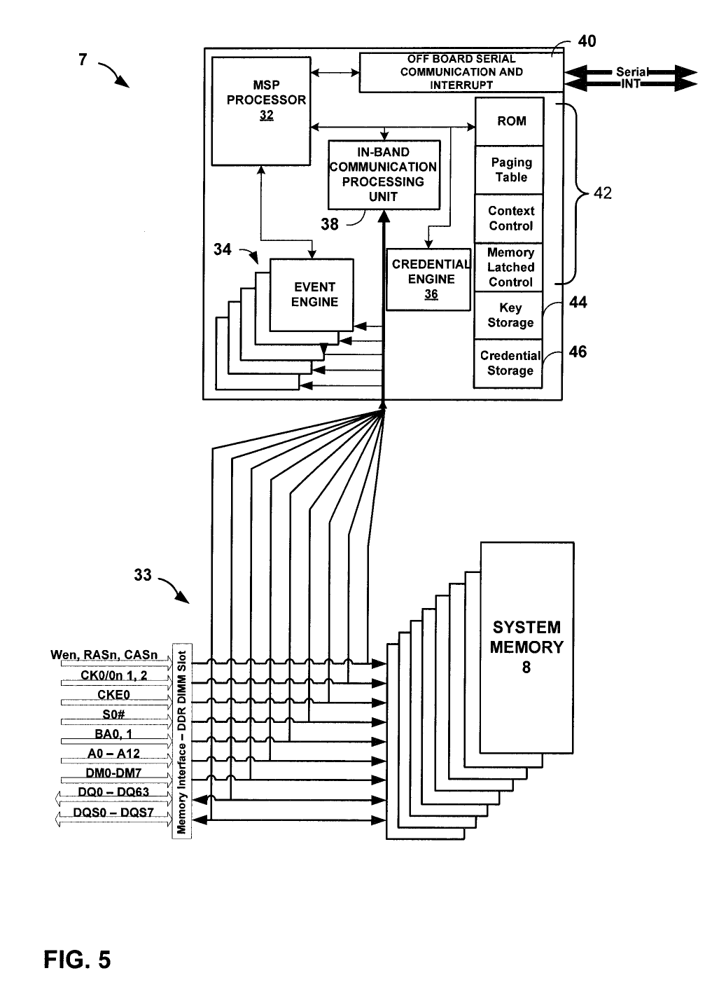

FIG. 5 is a schematic representation of an exemplary hardware portion of MSP Security Controller 7 when inserted and operating as a memory protection device in a computing system, such as computing system 1 of FIG. 1.

In general, MSP Security Controller 7 comprises the typical elements found on a compatible “memory stick” in order to monitor memory interface 33, and includes additional logic to provide specialized security functions. Because MSP Security Controller 7 is compatible within a “current day” PC system, such as computing system 1, the MSP Security Controller 7 may operate within timing requirements where memory busses are tuned to achieve high-speed bulk transfer of memory data.

In the example of FIG. 5, MSP Security Controller 7 includes an MSP Processor 32, a set of one or more Event Engines 34, a Credential Engine 36, an In-Band Communication Processing module 38, Off Board Serial Communication and Interrupt 40, Memory Area 42, key storage area 44, and Credential Storage 46.

MSP Processor 32 is an embedded micro-controller, which directs all aspects of the MSP Security Controller 7 within the memory module.

Each of event engines 34 is a configurable logic block with the primary purpose of watching (i.e., snooping) system memory 8 as the data transfers are normally communicated between memory controller 4 and the memory modules of system memory 8. In some exemplary embodiments, MSP Security Controller 7 includes a plurality of parallel Event Engines 34, each with the ability to view a stream of memory transactions as the transactions would normally occur at real-time system speed. An “event” may be a programmed event (or sequence of events) that may comprise a particular data stream or address location accesses and the like. Each of Event Engines 34 has the ability to view all memory accesses within the stream and detect matching events.

As an example for illustration purposes, sample Event Engines #1, #2, #3, #4 may be configured to look for various rogue virus streams. Sample Event Engines #5-#n may be configured to determine if particular addresses or range of addresses are accessed from the memory controller to the memory elements within system memory 8.

MSP Processor 32 programs Event Engines 34 monitor memory access requests between CPU 2 and system memory 8. In addition, MSP Processor 32 programs Event Engines 32 to determine whether the monitored memory access requests constitutes security threats. For example, MSP Processor 32 may provide context information from ISO module 9 and/or configuration data to configure Event Engines 34 with respect to the particular memory transaction or series of transactions that Event Engines 34 are to monitor. In another example, the security threat may include a request from a software application to access data stored in system memory that is associated with another software application. In yet another example, Event Engines 34 may monitor a plurality of memory access requests between CPU 2 and system memory 8 and determine whether a pattern of the memory access requests constitutes a security threat. That is, Event Engines 34 may determine that individual memory access requests do not constitute a security threat individually, but a set or series of memory access requests as a whole may be a security threat. The Event Engines 34 may, additionally, monitor a plurality of memory locations for content, with or without consideration of units of time, to determine if such conditions constitute a security threat or monitoring event.

Event Engines 34 may assert response messages (e.g., flags) to MSP Processor 32 when Event Engines 34 detect matching events (e.g., a security threat) within the stream of memory transactions monitored by MSP Security Controller 7.

Credential Engine 36 is a configurable logic block with the primary purpose of constructing, managing and storing both standard and dynamic user and application credentials. Standard credentials are the security items typically associated with a user to gain access to network and domains. Dynamic Credentials are security items used to protect access to specific software applications such as desktop programs or web systems. Specifically, a Dynamic Credential is an encrypted, time-stamped, application-context sensitive control string that uniquely identifies an application user and provides protected ties to that user's unique application data. Credential Engine 36 provides a secure storage and access mechanism for Standard Credentials. Credential Engine 36 provides a unique construction mechanism and secure storage and access mechanism for Dynamic Credentials.

In-Band Communication unit 38 is responsible for determining if a series of memory reads or writes is typical memory access or, instead, a communication packet to configure components of the MSP Security Controller 7 itself. This concept of MSP Security Controller 7 allows ISO Module 9 to control registers within MSP Processor 32, configuration data for Event Engines 34, data for Credential Engine 36, a Paging Table, and read/write operations with a memory-latched control board. In-Band Communication Processing unit 38 may be able to determine if a memory access is simply a standard memory access, or is a unique memory transfer that allows data to be latched within this unit over the standard memory bus.

Off Board Serial Communication and Interrupt port 40 provides an off-board serial communication port that allows for an alternate path into MSP Security Controller 7. This component can be used for initial setup of MSP Security Controller 7, as well as a communication link between multiple MSP Complex units within a system or multiple device deployment. The MSP Interrupt Signal (INT) has the ability to interrupt the standard interrupt hardware structure within the host system, e.g., computing system 1. This feature is used to immediately alert computing system 1 upon triggering of an Event Engine flag.

Memory Area 42 comprises of four primary areas: a Read-Only Memory (ROM) area, a paging table area, a context control area, and a memory-latched control board area. The ROM area of memory area 42 is a read-only area of memory area 42 that may store software that is executable by MSP Processor 32. For example, the ROM area of memory area 42 may contain software that MSP processor 32 uses to boot. The Paging Table area of memory area 42 may store ownership information of memory blocks. The Context Control area of memory area 42 may store context information about the owner of the memory including state and control elements from Program Executive 4, CPU 2 and associated components.

The Memory-Latched Control area of memory area 42 may store command-and-control information for MSP Security Controller 7, and indirectly for ISO Module 9. The Memory-Latched Control area may provide a latching memory mechanism by which ISO Module 9 and MSP Security Controller 7 may share information from the standard memory bus slot. MSP Processor 32 posts information to the Memory-Latched Control area and may then cause that information to load into system memory 8 associated with the ISO Module 9. ISO Module 9 can indirectly write and/or read information, including Event Engine status, from the Memory-Latched Control area by directly writing or reading the system memory 8 associated with the ISO Module 9 and recognized as be “latched” by the MSP Processor 32.

MSP key storage area 44 is a non-volatile memory section within MSP Security Controller 7 that only MSP Processor 32 is able to read. MSP key storage area 44 may store mappings from sets of ownership information to encryption keys. For example, MSP key storage area 44 may include a mapping from a set of ownership information for a first person to an encryption key. Programming an initial key may be accomplished via Off-Board Serial Communication path 40. As a result, it may be virtually impossible for any rouge software applications executing on host computing system 1 to gather access to MSP key storage area 44 of MSP Security Controller 7.

Credential Storage 46 is a non-volatile memory section within MSP Security Controller 7 that can only be read from the MSP Processor 32. Software applications can request Credential functionality of MSP Security Controller 7 via ISO Module 9 and Credential Engine 36. This feature provides dynamic security elements that help protect system, application and user data from outside attack. As a result of the architecture, it may be virtually impossible for any rogue code executing on computer system 1 to gain access to Credential Storage 46.

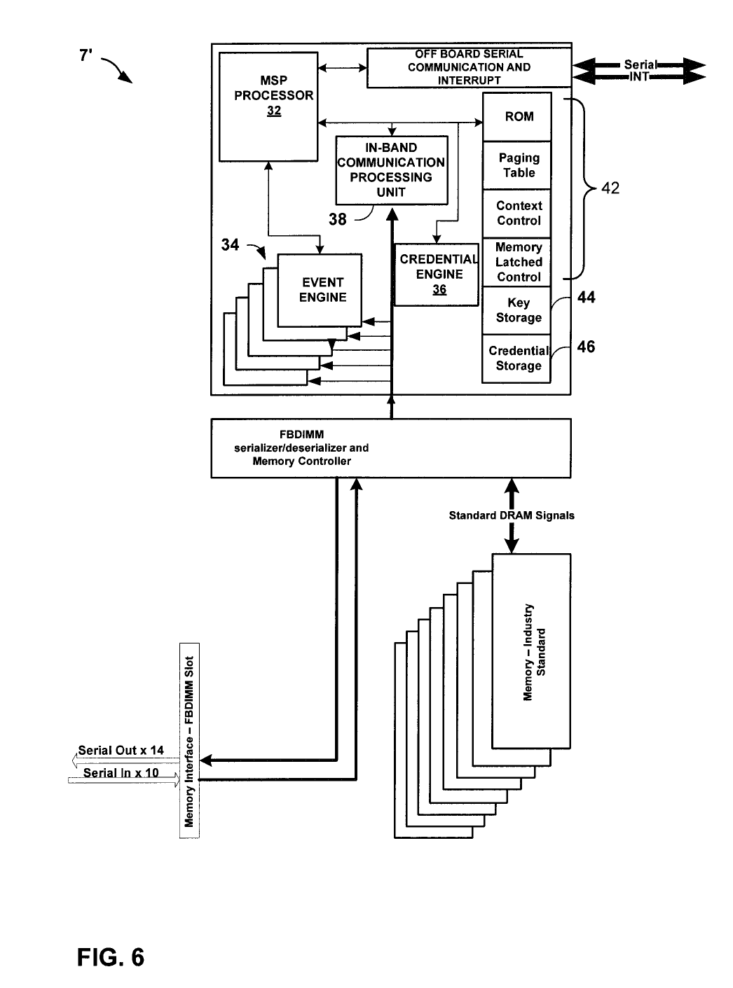

FIG. 6 is a block diagram illustrating a second implementation 7′ of the Memory-Security Platform (referred to as an “MSP2”) constructed with fully-buffered dual in-line memory module (FBDIMM) type memory. In this example embodiment, MSP2 exploits very fast serial communications, such as that employed by recently developed FBDIMM specification.

The fast serial communication method typically relies on a high-speed serial communication using well-tuned differential logic. For example, the serial communication of FBDIMM utilizes a Serializer-Deserializer (“SERDES”) device to transfer the serial communication into parallel data signals such as to memory elements.

Such memory transfer mechanisms are fast, but may take many clock cycles overhead (latency) to actual start a transfer packet. Once started, the packets can achieve bandwidth greater than previous design parallel transfer data busses. One potential advantage of MSP2 is that the serial communication latency period may be used to perform security functions on the memory request or actual data elements. This may provide a “packet inspection” protocol with potential comparison logic that is dynamic or preloaded into a comparator. This MSP2 security mechanism may be enabled with the comparison values on a “shadow RAM”, or supplied dynamically with the same via a secure interface. Systems designed using a serial communication to system memory scheme enables programmable registers to make memory packet transfers deterministic in time.

Alternately explained, with high-speed serial communication memories, a system designer can assume a standard latency before a memory read packet is expected to be returned by memory to the requesting memory controller. Based on this system value, the MSP2 can provide different levels of security operations. For example, if this timing parameter is set tightly, MSP2 can offer a certain level of packet inspection security operations. However, if this value is set to a higher latency, offering more inspection time, a more thorough set of reviews can be implemented on the system. In general, a computing system is not sensitive to a lengthened memory cycle as long as a latency timer for the computing system is set appropriately. Moreover, only slight performance degradation occurs with a high level of latency. The MSP2 mechanism may also allow injecting into the code stream where such operations were previously difficult from a timing perspective.

Isolation Module (ISO Module) 9 functions as an executive kernel or hypervisory component that executes as a monitor of computer system operations that MSP Security Controller protects; communicating critical task, memory and operational state information from computer system 1 to MSP Security Controller 7. If implemented as a software component, ISO Module 9 is backed by the hardware power of MSP Security Controller 7 to help ensure that it always remains resident in the OS or hypervisory executive program of computer system 1. If a virus, spyware or rootkit intrusion should ever attach, discover and breach the security mechanisms of the software ISO Module, rendering it inoperative, MSP Security Controller 7 would detect the disabling or other interference with ISO Module 9 and prevent further access to the memory module of the system. Alternatively, ISO Module 9 may be implemented as control circuitry within CPU 2 or memory controller 4 to provide even greater security provisions.

Specifically, ISO Module 9 transmits context information from the application, OS and/or executive program operations to MSP Security Controller 7 such that MSP Security Controller 7 can enforce memory protections from rogue code execution and even from legitimate OS or executive program code under certain conditions. Additionally, ISO Module 9 utilizes a cooperative mechanism to check, detect and block memory operations that are executed on behalf of an “unregistered” (hidden) task or process and help illuminate unauthorized activity that is common to virus, spyware and rootkit intrusions.

ISO Module 9 places itself within critical operational procedures in order to collect, affect and communicate computer operations. In one embodiment, ISO Module 9 may take the form of an OS Kernel Driver and perform actions that may be comparable to a “rootkit”—the very thing that the MSP seeks to block. However, ISO Module 9 may also be migrated directly into core OS or executive programmatic code in order to better integrate and access key control and context data. As mentioned previously, as future computer systems are designed, portions of ISO Module 9 logic may find their way into CPU 2 and memory controller 6 circuitry.

ISO Module 9 is responsible for providing executive program/operating system/task and memory context information to MSP Security Controller 7 in order to provide advanced security features. In one embodiment, ISO Module 9 is typically embodied as an OS or Exec kernel module and/or a CPU functional unit.

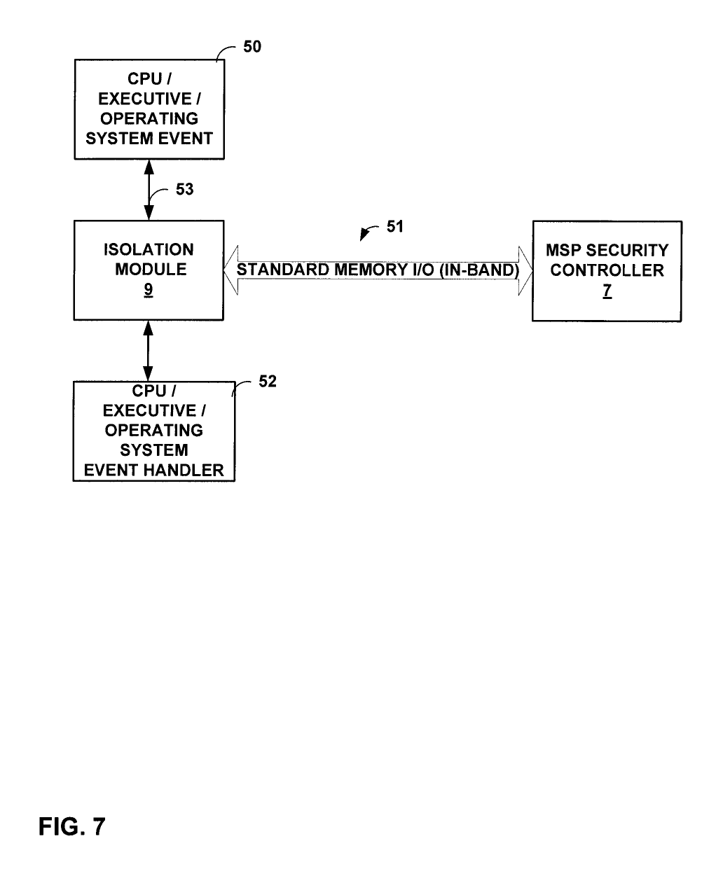

FIG. 7 is a block diagram illustrating an exemplary ISO Module 9 intercepting process context and memory page-fault invocations 53 and communicating that information to MSP Security Controller 7 via the standard memory bus mechanism 51. The context information is used by the MSP to map memory allocations into the security circuitry and provide security access control features in real time. In the example of FIG. 7, ISO Module 9 is illustrated as an added Kernel Mode component of the OS, but ISO Module 9 may also be deployed as a native Kernel Mode component or integrated directly into CPU 2 or the memory controller 6, e.g., a Northbridge controller.

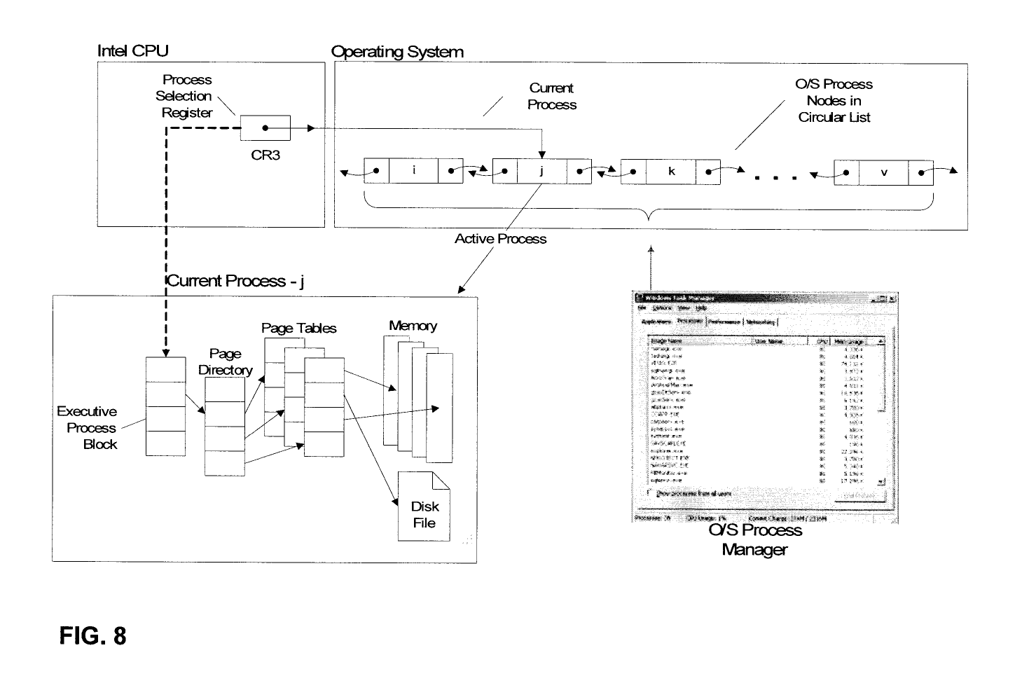

FIG. 8 is a logical diagram showing an exemplary computational environment in which ISO Module 9 operates. The diagram depicts a CPU containing a process-selection register that points to the currently running task or process within a single, standard operating system. The OS maintains page tables or data structures for each process in the system. The data structures maintain reference to the process disk image and memory page allocations.

As the CPU attempts to run a process instruction, it may fail because the instruction has not yet been loaded into memory from the computer disk. When this “page fault” failure occurs, the executive program or OS triggers a special piece of kernel code typically called the Memory Manager (“MM”). The MM locates the portion of disk file that contains the task's currently needed instruction and loads it, along with a surrounding “block” of disk program, into physical system memory. This process is known as “paging.”

As part of the normal operating process of the computer, paging occurs almost constantly. As each program or executive code segment is loaded for operation, it triggers a page fault and then the MM to load or page the required code into memory.

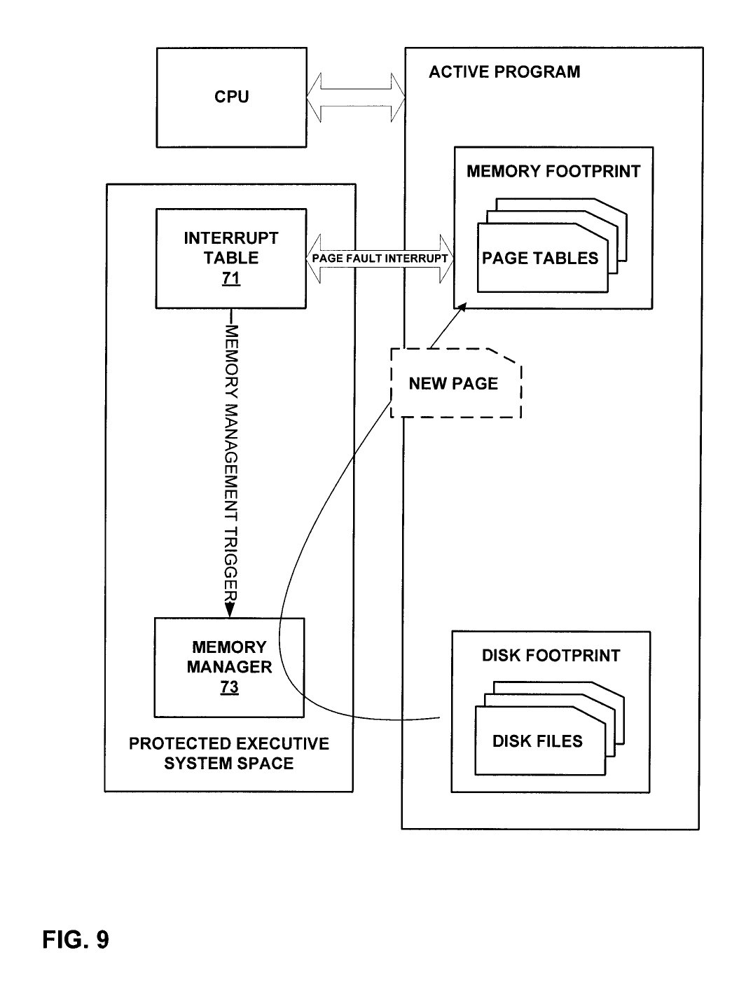

FIG. 9 is a block diagram that depicts an example standard operational flow of a computer system as it attempts to run an active process. As needed, application logic is loaded from disk to memory via the executive program or OS Memory Manager. More specifically, in response to a page fault interrupt, interrupt table 71 triggers OS Memory Manager 73 to retrieve a new page of memory and place within the page tables, i.e., memory footprint, for the active program currently being executed by the CPU.

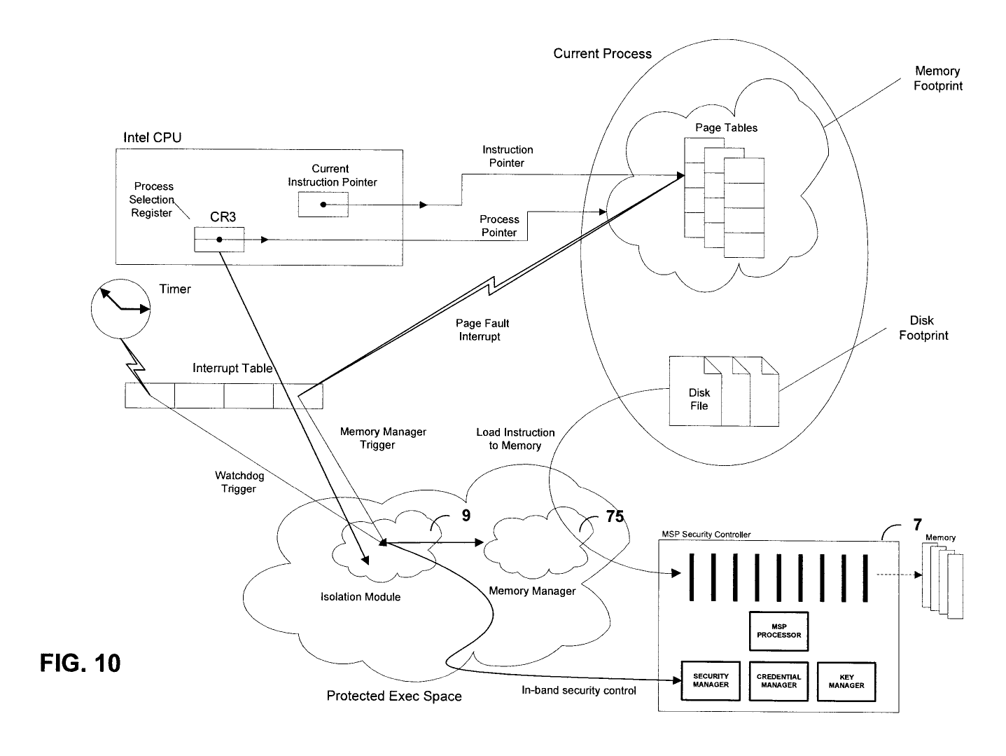

FIG. 10 is a block diagram illustrating an example ISO Module 9 in an exemplary computation environment. In this example, rather than a hardware component, ISO Module 9 shows as a software component in the system, running in the protected Exec or OS space intercepting context and page fault/memory allocation paging requests. The “next instruction” on the application or system triggers a page fault, resulting in a memory allocation and partial load of the program from disk. As the request is dispatched to Memory Manager 75, ISO Module 9 intercepts and wraps the event such that the ISO Module 9 may collect individual memory allocations and mappings for the computer system 1. ISO Module 9 then communicates this information to MSP Security Controller 7 over existing memory I/O channels, i.e., in-band communication. After transmission, MSP Security Controller 7 contains individual memory page mappings.

An alternate description is that MSP Security Controller 7 is able to determine that memory a given page(i) belongs to a corresponding application(j). The diagram also depicts ISO Module 9 intercepting CPU, Exec, or Operating System events, and collecting process and operational information from the Exec control program and system hardware components in order to provide MSP Security Controller 7 with process and context information related to system operation. ISO Module 9 communicates this information to MSP Security Controller 7 in a similar fashion to that which is used for memory allocations so that the Security Controller can then offer advanced protection to the application or Exec program and its associated data/program contained within the memory. The example of FIG. 10 also depicts a triggering of ISO Module 9 on a watchdog cycle in order to ensure that ISO Module 9 reports into MSP Security Controller 7.

One key to a successful security platform may be its ability to support standard processing operations as well as provide a solid base for protected security operations. As such, embodiments of the MSP may utilize several unique security processes and procedures.

As mentioned previously, MSP Security Controller 7 may contain numerous security stations or “Security Blades” 22. Security Blades 22 may be individual logical processing units that may impart security operations on both the memory I/O request and response, and against the memory module itself in a background-processing mode. The Security Blade operations may be executed in parallel, or serially, in order to achieve the desired security or management effect.

For situations where the desired security/monitoring steps are too time intensive for execution within the memory request/response time allotment, MSP Security Controller 7 may process the steps against memory in the background in a deterministic manner.

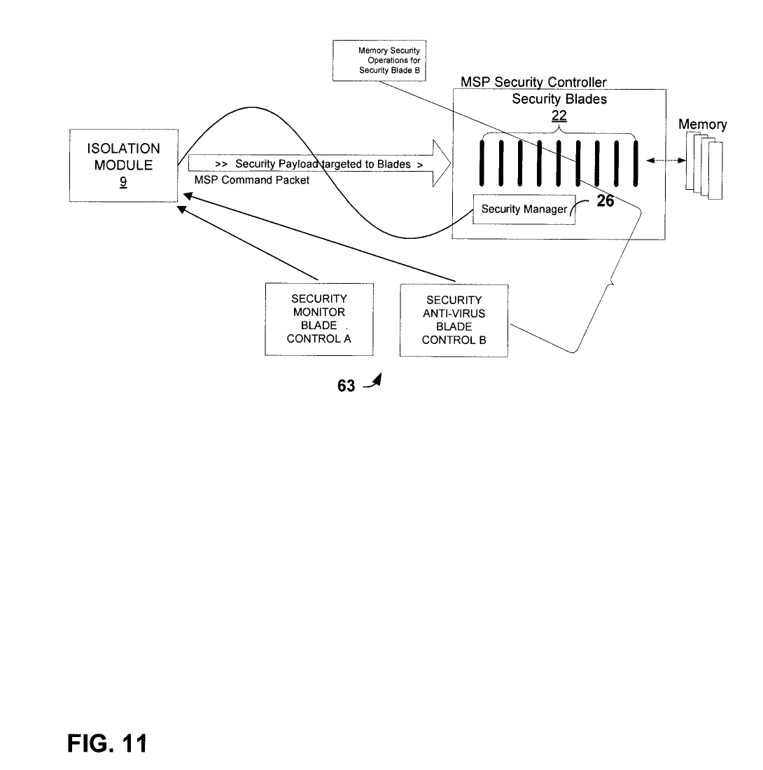

FIG. 11 is a block diagram illustrating an exemplary embodiment of a MSP using programmable security blades. Security Blades 22 are logic components that are resident in MSP Security Controller 7. Security blades 22 implement a cooperative component of its third-party developer's security offering. Security Blades 22 have hardware processing power to monitor and control memory operations, as does the native MSP Security Manager.

In this example, FIG. 11 shows how a particular configuration might support various third-party vendor security offerings 63. The example of FIG. 11 shows security monitoring logic from vendor A, and an anti-virus logic offering from vendor B. Each of Security Blades 22 may be configured through the ISO Module 9 and the associated vendor's MSP-compliant control software, but the “execution” or processing of the security logic is performed by, and from within, the MSP hardware.

In this manner, MSP Event Engines 34 (i.e., logical Security Blades) are controllable blades that may be configured via command packets directed to MSP Security Manager 26. MSP Event Engines 34 are capable of performing the stated security operations on the specific memory I/O request, or they can scan the actual memory chips on a virtually continuous basis.

In this example, Security Blades 22 may contain multiple levels of security logic. For example, one type of logic might be the standard signature-based byte-comparison check used typically by anti-virus vendors. The difference in this example is that the signature operations would run in isolated MSP hardware, and against system memory in real time.

Another type of security logic would be handled completely within the memory I/O request cycle between CPU and the memory stick. This operation would provide real-time security features currently unavailable.

Yet another type of security logic would include the “context” information available due to the interaction of ISO Module 9 and MSP Security Controller 7. This configuration would allow advanced security and monitoring operations that are more comprehensive than signature-only solutions.

As mentioned previously, one feature of the MSP is that MSP Security Controller 7 can interject security mechanisms into the memory I/O request, ensuring that the memory response meets security guidelines or standards. These checks are performed in real-time and are unaffected by potential virus or rootkit modules installed on the host computer or digital system.

Additionally, the MSP can apply the security steps to the memory subsystem on a continuous basis in order to maintain specific security levels or apply broader security logic. Moreover, the MSP can perform these security/monitoring operations without negatively affecting native system performance or diminishing bus throughput.

Depending upon configuration, advanced security and monitoring information is communicated back to compliant MSP cooperative control programs on the computer, or off-system to a central management site, for user and management review.

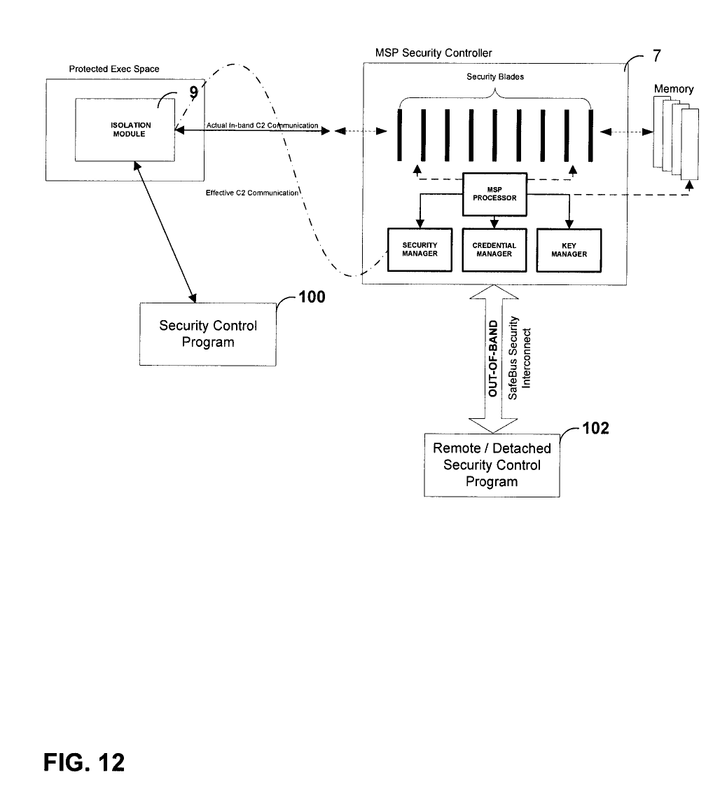

FIG. 12 shows an example block diagram of MSP Security Controller 7 communicating security information back to a security control program (SCP) 100. As conditions change on the computer or digital device, so does memory and the resulting security state. MSP Security Controller 7 may provide a summary or detailed view of the security state back to the respective Security Control program(s). MSP Security Controller 7, via standard existing memory channels, communicates the security-state information through ISO Module 9 to Security Control program 100. Additionally, MSP Security Controller 7 may communicate this data over a SafeBus Security Interconnect to local, detached or, remote Security Control programs 102. As discussed in detail below, a “SafeBus Security Interconnect” is a physical interconnect that facilitates out-of-band communication between MSP Security Controller 7 and a human security operator.

Generic Memory, Memory Controller and CPU Imbedded

The MSP concept may be applicable even when “pluggable” memory slots are not available. The same approach can be used in memory applications such as the Smart Phone or other processor-based digital appliance having a limited footprint. The same apparatus and art that enables the MSP are applicable to non-pluggable memory systems. The main difference is the physical location where the enabling hardware is soldered next to the memory components in such devices.

In some embodiments, aspects of the MSP concept are embedded directly into the memory controller or CPU itself. For purposes of example, the document has been describing the concept of providing MSP logic on a memory stick or alongside of memory elements. However, all or portions of the logic and art described herein can sit inside a portion of the memory controller and provide the same function. Moreover, if this logic were implemented inside the memory controller or advanced CPU, a designer may have the ability to “relax” the timing constraints on the memory transfers and all operation described in the document would be fully available to all memory subsystems in all platforms.

SafeBus Security Interconnect

In one embodiment, the MSP uses a SafeBus Security Interconnect (“SSI”) as an out-of-band physical communication medium within the computer system to transmit and receive critical operational data and control between logical MSP Security Manager 26 and the human security operator. In other words, SSI is not a memory-mapped interconnect. Such functionality may also be provided over standard communication mechanisms if the flow endpoint terminates directly at the MSP.

By using an out-of-band approach, the MSP ensures that sensitive control information is not disseminated over corrupt or breached communication channels within the host computer or digital appliance.

Some of this sensitive information may be bound for the Security Control Program and that is a standard User Mode application. Therefore, in one embodiment, ISO Module 9 performs initial security functions against the host computer system (keyboard loggers, rootkit detection, hooked system function calls) to ensure that the sensitive data is not exposed to rogue components within the computer system.

The SSI delivers such information and receives such control inputs from an optional Mobile Security FOB (“MS fob”) that connects to the SSI through a special connector, as well as other SSI attachments that are used to transmit control and data sequences outside the computer system in a more secure global fashion—more akin to an encrypted, network interface.

The SSI facilitates the capture and emulation of memory I/O operations outside the host computer system to provide state and memory access playback feature to facilitate training, development and security research. This also includes compliance, logging and enforcement procedures that monitor and block operations as mandated by various regulations and laws.

Mobile Security FOB

The Mobile Security fob (“MS fob”) is a piece of optional MSP hardware that a user may utilize to securely interact with MSP Security Manager 26 and Security Control Program. For example, an MS fob may be a small device that a user may attached to a keychain or carry in a pocket. To use an MS fob, the user may insert the MBFOB into an SSI port in an external housing of the MSP. The port may optionally be a Universal Serial Bus port that connects directly to the SSI. By using existing interconnects to the computer, the MS fob may provide a security user with the ability to configure and control the invention. By using the out-of-band communication path provided by the SSI, a security user can manage and regulate both the operational MSP hardware and ISO Module 9 through even more secure communication channels.

The MS fob contains encrypted storage that allows a security user to store control information needed to protect MSP command-and-control and other important operations. Additionally, the MS fob may provide input controls to manage and direct special operational features of MSP Security Manager 26 and MSP Security Controller 7.

A particular MS fob may be interoperable with numerous MSP Security Managers and MSP devices to allow a managing security operator to move from computer system to computer system configuring or managing MSP inventions as needed.

The MSP may also allow the MS fob to initiate management control, monitoring and data collection activities remotely to MSP devices.

The MS fob maintains strict security partitioning between the various instances of control information contained within.

Security Control Program

The MSP Security Control Program (“SCP”) is a User Mode application that can be used to interact with and control much of the operational features of ISO Module 9 and MSP Security Controller 7 (outside of MS fob control). The SCP provides the security operator on the computer system with the access to key information and components of the MSP.

The SCP interacts with the user and then relays those commands and controls needed to operate the MSP to ISO Module 9 via encrypted communications. In order to effectively provide this command-and-control operation, the MSP uses a cooperating method of protection between the MSP Security Manager, ISO Module 9 and the SCP. Each of these components is used to help protect the others.

Embodiments of this coordinated protection scheme include the transmission of critical control data from the MSP Security Manger through the MS fob (via the SSI).

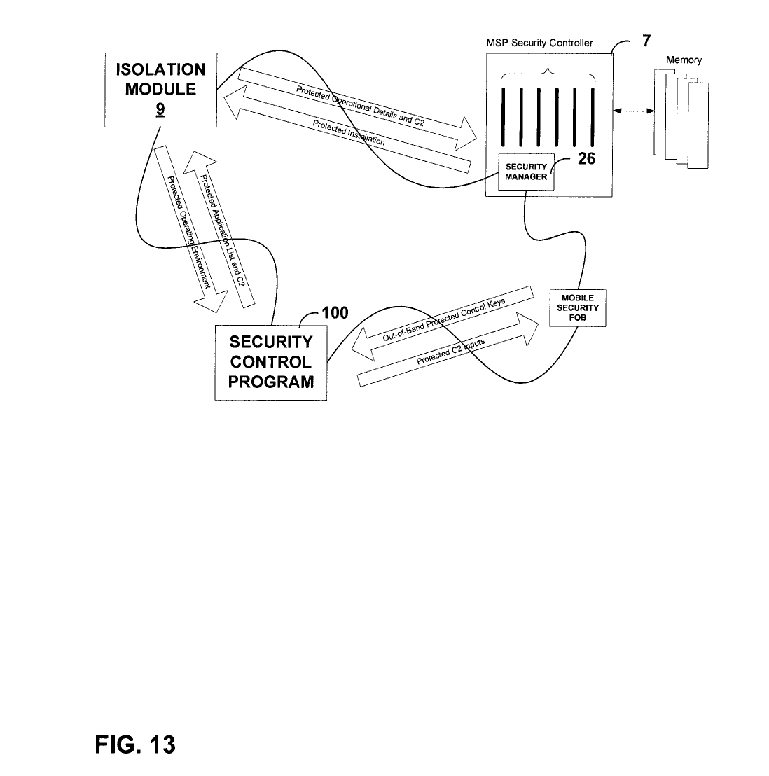

FIG. 13 is a block diagram illustrating the cooperative security mechanism used to ensure the safety of the various MSP components. ISO Module 9 is installed and secured by MSP Security Controller 7. ISO Module 9 protects the core Exec space such that the SCP 100 has a protected operating environment. The MS fob interacts with MSP Security Manager 26 via the SSI to receive and send critical configuration information. The MS fob presents the security user with this needed information and control input in order to bridge the gap between the Security Control Program and the MSP Security Manager. The SCP provides the security user inputs in protected format to ISO Module 9 for activation.

Command-and-Control

The command-and-control interaction between the ISO Module 9 and MSP Security Manager 26 may flow across a standard memory bus using traditional memory operations. Due to the unique nature of the MSP, MSP Security Manager 26 activates the MSP Command Packet (“MSP-CP”) via the Memory Latch mechanism, upon MSP-CP's transmission from ISO Module 9 to standard memory 8 associated with ISO Module 9.

MSP Security Manager 26 captures the MSP-CP and validates its secure control mechanisms before carrying out the requested functionality.

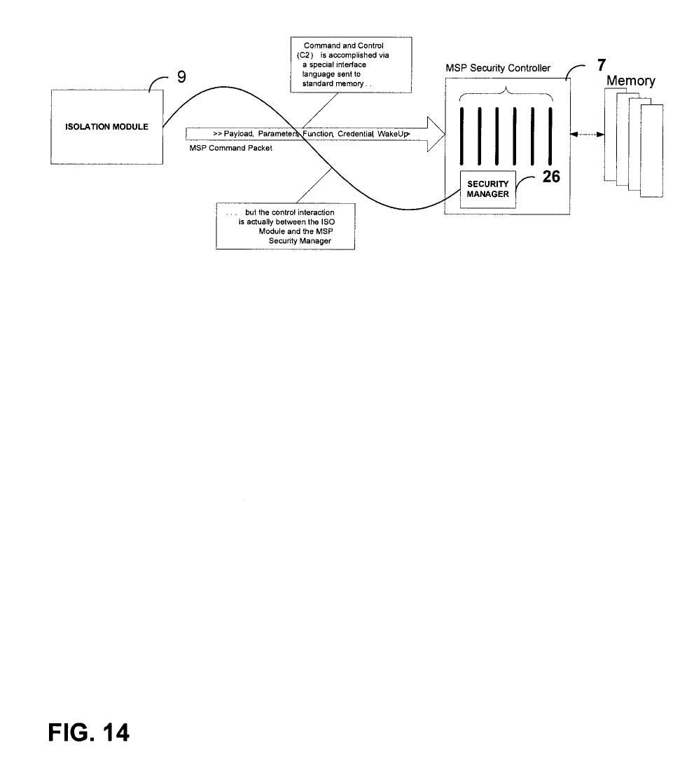

FIG. 14 depicts a sample MSP Command Packet as it traverses the standard bus from ISO Module 9 to memory. Effective control, however, passes from ISO Module 9 to MSP Security Manager 26.

The MSP-CP request travels in-band, as does any required response from MSP Security Manager 26. MSP Security Controller 7 processing (Security Blades, MSP Processor, Security Manager, Credential Manager, Key Manager, etc.) may occur in a side-band mode that is mainly independent of host computer operations (some interaction may occur when the MSP applies in-line filtering and response actions on the standard memory request).

Memory Word Inspection in Real Time

One aspect of the MSP is that it is able to inspect memory transfers in real-time at full system speed [e.g., MSP2], or at near full system speed [e.g., MSP1], in addition to extending the clock cycles of MSP2-type systems to gain even more security, management and monitor processing power. The extended-cycles processing, that is, auxiliary processing logic against memory I/O after the host system has issued its memory request, is an extremely powerful and novel concept. In essence, harnessing the available extended cycles delivers a powerful pipelining effect to improve overall security and increase flexibility of processing operations. Additionally the MSP may continually look for Event Engine matches when the host system processor does not have any immediate memory need. This may allow a constant scanning of host system memory regardless of the processors memory accesses.

When combined with the additional host system context information supplied b ISO Module 9, this unique processing capability may generate advanced security capabilities not available with existing security solutions. For example, this unique processing capability may enable the detection of previously unknown rogue code or new virus segments, typically called “zero-day exploits”.

Unique Key Information on Memory Apparatus Hardwired

MSP Security Controller 7 memory may have the ability to hold (in non-volatile memory such as EEPROM or Flash) unique keys associated with the host computing system where MSP Security Controller 7 is installed. Additionally, the MSP can contain command-and-control keys that are used for command-and-control. The MSP may utilize a direct pathway outside the box, giving MSP Security Controller 7 direct communication to an outside source that is completely outside the processor code stream for programmable security functions. FIG. 12 (described above) illustrates an exemplary MSP Security Controller 7 that is capable of direct communication to an outside source that is completely outside the processor code stream for programmable security functions using an out-of-band interface, i.e., a protected interface separate from the memory bus of computing system 1.

Memory Word Inspection Side-Band

This section describes an exemplary method for on-the-fly Memory Word Inspection. Memory that passes the memory subsystem may be checked, without speed degradation, for virus or rogue code segments. However, there is a practical design limit when performing this function, i.e. only a certain number of live comparisons can be done at any one time in a given memory I/O cycle.

This memory concept adds two unique aspects to enhance security checking of system memory.
(A) Memory Word Inspection Side-Band is an approach to check large virus or rogue segments across the system memory. In this embodiment, the active logic on the MSP Security Controller 7 acts as a memory controller itself and is able to ripple through all memory Rows and Columns (via control of the RAS, CAS, Address) to continually check for virus, rogue or unauthorized segments at all times that system memory accesses are quiet. If the host computer system is not running routing memory reads/writes, the MSP Security Controller 7, resident inside the memory stick (or imbedded into the CPU or system Northbridge Chip), may continually access memory systematically until the entire memory stick is checked. It may start a check swiftly and stop at any time as not to upset the standard memory access. The MSP Security Controller 7 then rolls over to the first address and starts again. Note that this method is better suited towards an increased latency memory, or if the designer has access time adjustment of current-day memory controllers. Stated differently, this concept can work well on current architectures if the Northbridge access times are relaxed slightly.
(B) Because the MSP uses in-band command-and-control (i.e. can gather instructions on what to do via simple memory transfers via the Memory Latching mechanism), the MSP may have the ability to download and accept new virus-protection configuration information at any time. The virus-protection configuration information may control limited aspects of the behavior of the MSP, but is not independently executable software code. Such virus-protection configuration information may be aimed at the MSP's unique Side-Band inspection of memory. Alternatively, security measures could be aimed at the in-line memory I/O operation (Memory Word Inspection in Real Time), where the in-line logic is updated at certain time intervals to supplement the number of live comparisons that can be checked within a limited I/O cycle.
   In-Band Control Signaling

Embodiments of the MSP make use of in-band control signaling between the MSP control software and the hardware of the MSP. This mechanism may utilize a control structure that allows computer system designers to maintain the existing footprint and form factor of current day computer systems, and allows standard memory bus mechanism to provide command-and-control structure for the MSP. ISO Module 9, and other MSP protected applications and drivers, can safely communicate functional control information to the MSP Security Manager. The example of FIG. 14 illustrates an exemplary control structure that allows a standard memory bus mechanism to provide a command-and-control structure.

Side-Band Security Operations

Embodiments of the MSP make use of special hardware circuitry that offers memory security operations in parallel with existing memory connections. The design allows CPU/Northbridge and DMA operations to access the memory modules without outside contention from the MSP. This is a unique MSP design that provides memory monitoring and access without adding contention problems plagued by standard PCI hardware or other security solutions.

Security Credentials and Encryption Key Storage

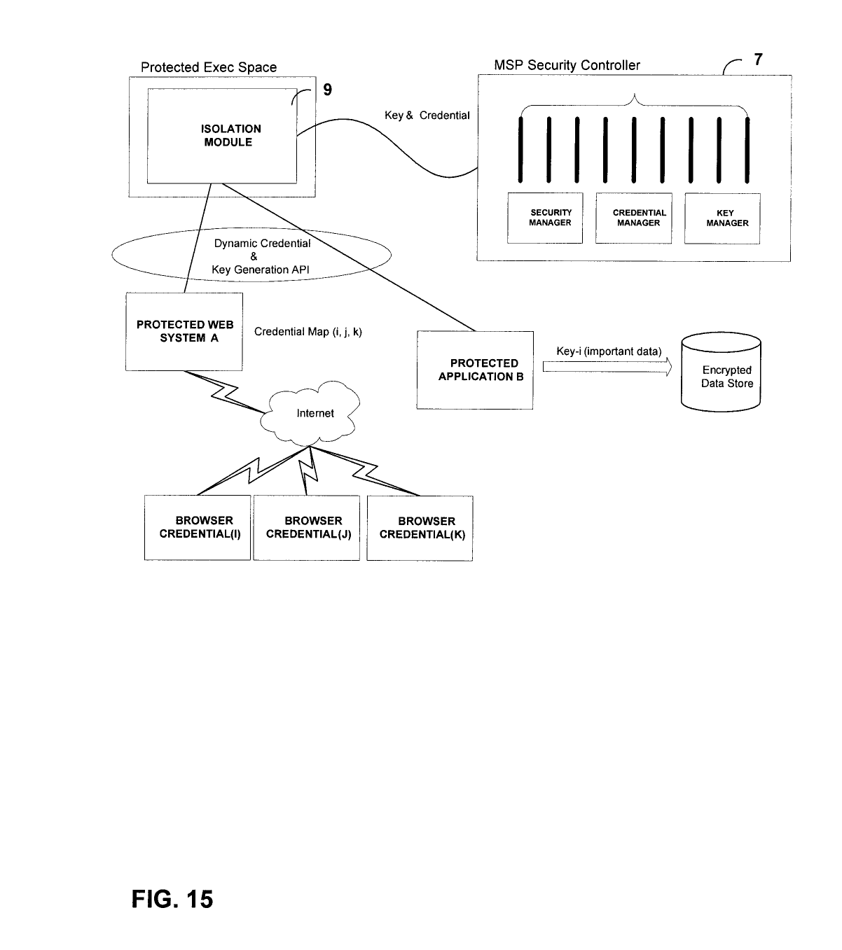

FIG. 15 is a block diagram illustrating an exemplary dynamic mechanism to generate, disseminate, store and control access to important access credentials and encryption key control strings.

Special circuitry (i.e., the Credential Manager) on MSP Security Controller 7 may generate dynamic versions of the Credential and Encryption Keys as needed to manage MSP security and/or application and Exec operations as mandated by security needs.

These protected security tokens can be delivered via ISO Module 9 to the OS or Exec and applications to help make those components more secure in their operational capacity, or the tokens can be delivered out-of-band via the SafeBus and MS fob devices to allow critical control flow outside of normal system channels.

Such security tokens, and the management thereof, are essential for the safe operation of the computer systems and for the protection of user data contained or transformed by the computer system and associated programs.

Cooperating Security Initialization

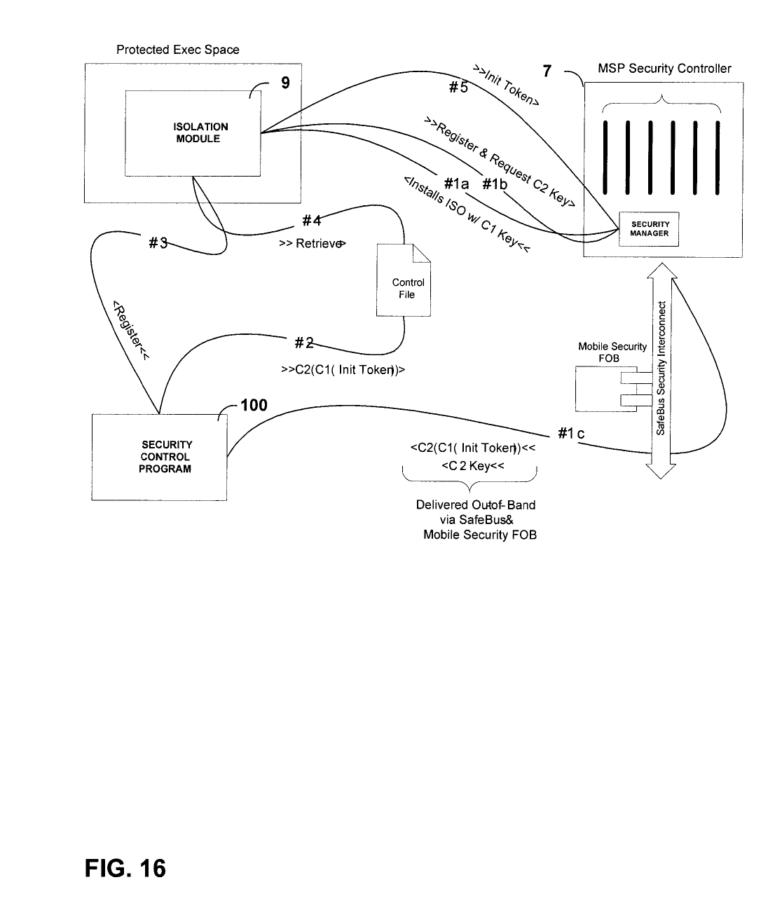

FIG. 16 is a high-level block diagram illustrating an exemplary system that uses a method of cooperating-process initialization (“CP Initialization”) to initialize itself and the host computer system 1 in which the system is installed. Through this mechanism and operational procedures, the MSP can ensure that higher level of protection of its critical components from the threat of breach, eavesdropping or even complete removal of operation that plagues existing security solutions.

A simplified picture is provided in FIG. 16 to illuminate the cooperative nature of the MSP's primary components. The MSP Security Controller 7 interacts with the MSP Security Manager 26 to install and prep ISO Module 9 used within the OS or Exec system. Additionally, MSP Security Manager 26 makes use of the SafeBus and Mobile Security FOB to transmit and receive sensitive initialization information out-of-band to and from the security user configuring the system.

ISO Module 9, under full protection from MSP Security Controller 7 hardware helps ensure that the OS is clean and stable, thus providing security cover for SCP 100.

The sensitive control information is used in establishing the connection between the SCP 100 and ISO Module 9, and the connection is further protected via the security user's actions with the Mobile Security FOB (MS fob) to help ensure MSP communication integrity.

One feature of the MSP is that it offers hardware-backed protection of the critical software modules. This feature may ensure that the MSP security logic, along with any such logic as provided by authorized third-party security vendors, remains in operation. If some new forms of virus, spyware or rootkit intrusions seek to remove one of these protected security modules, the MSP hardware may block access to critical memory sections.

To extend the protective functionality of the invention, the MSP may make itself known to the installation process of the OS or Exec. For example, as the operating system is installed or updated, the OS will detect the presence of the device and securely communicate the existence of the new ISO-like module to the device so that the module can be footprinted; securely identifying the critical piece of software. Authorization of the process could flow through the installing user via the MS fob and/or SafeBus. This mechanism will allow OS or Exec developers to automatically invoke the protective cover of the device.

Integrated Command-and-Control Management

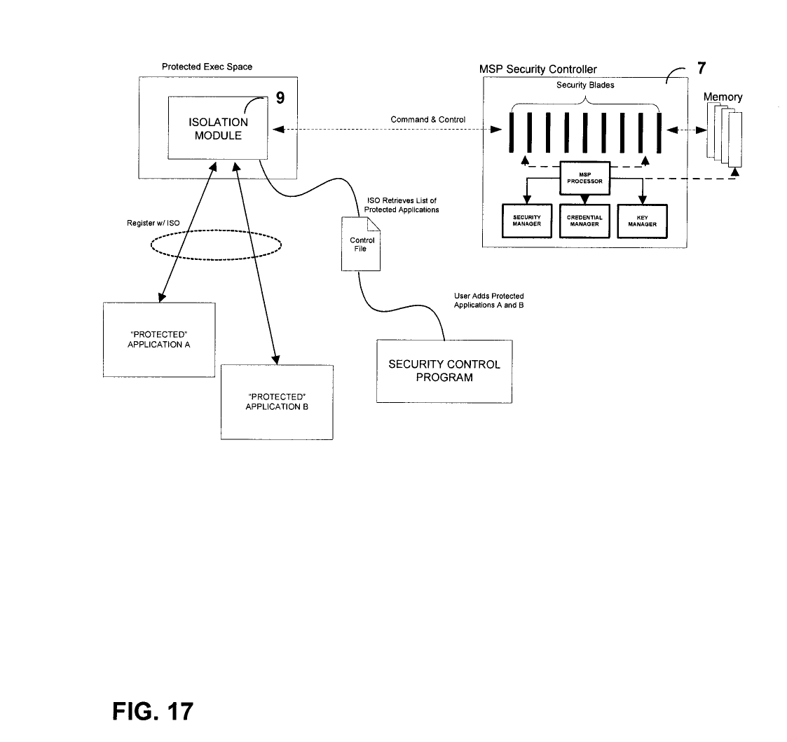

FIG. 17 is a block diagram illustrating an exemplary integrated command-and-control management mechanism. This mechanism offers system users the ability to securely add application and system software to the list of protected modules. Security users can monitor activity and escalate security functionality based upon need or scenario. Security and applications executing on the host computer may use an API to communicate and configure special activities via interaction with ISO Module 9.

Special Security Operations

The MSP uses several operations that help ensure a secure operating environment. Specifically, the MSP utilizes a Watchdog Control mechanism (not unique in itself) to ensure that the critical ISO Module is not removed from operation on the system. By protecting the presence and operation of ISO Module 9, the MSP guarantees that the functionality provided is running on the host system.

The Watchdog Control works in combination with the MSP's Dynamic Credential mechanism to provide a timely command-and-control heartbeat connection between ISO Module 9 and the MSP Security Manager. Failure of the Watchdog Control causes the MSP hardware to immediately stop access to system memory, thereby providing protection against data breach in the event a rogue component enters the host system and targets the MSP control structure.

Additionally, the MSP makes use of a Tracer Control feature that tests the host system's ability to deliver accurate data and control information. By utilizing a coordinated approach, the MSP can inject queries into the system in such a way that other parts of the MSP discover if the reported information from the host system is indeed valid and correct.

The Tracer Control mechanism helps to provide a level of confidence in the overall operation of the host system when potentially exposed to unknown virus, spyware or rootkit intrusions. This is very important in that most security offerings today use signature-based solutions. In other words, they protect against know threats. The Tracer Control mechanism helps discover system anomalies that may indicate breach by a yet-as-known threat.

Without such a self-check mechanism, the integrity of application programming interfaces and control information offered by the OS or Exec cannot be ensured as new security threats are increasingly stealthy and prone to destroying the integrity of system information to help the rogue program cloak its presence. This is especially true of hypervisor or virtual-machine-based intrusions that embed themselves below the level of the O/S, thereby making their presence potentially invisible to O/S-based detection mechanisms.

Dynamic Form Factor and Management

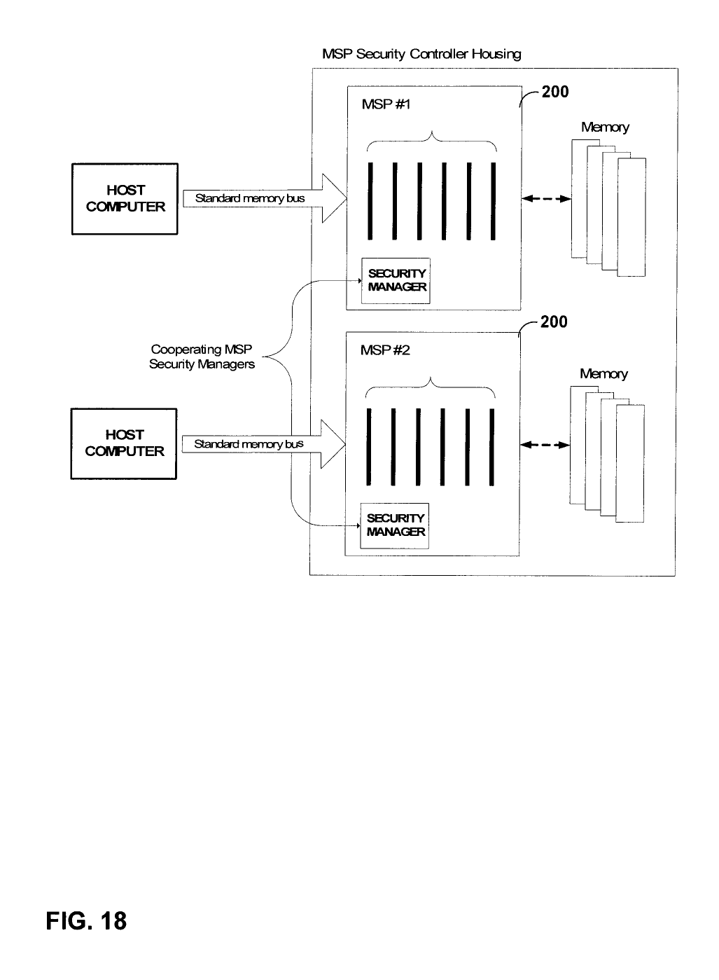

MSP Security Controller 7 may be rendered in several form factors to better suit the operational needs or application of the host computer. FIG. 18, for example, is a block diagram illustrating an exemplary embodiment of a MSP Security Controller 7 in a form that suits a “data center” scenario. Such an operation benefits from having the Security Controller reside out-of-host in a common command central chassis.

By integrating MSP Security Manager 26 units across host computer platforms (yet even optionally within the same Security Control Housing), the MSP can apply interactive security logic across multiple core memory units. As one problem or condition is detected, say, on computer(i), that discovery can be relayed to MSP Security Manager 26 on all other co-hosted MSP Security Controller units 200. This configuration is further supported by the extensibility of the new memory form factors soon to become available.

By utilizing the out-of-band SSI control conduit, the MSP can remote monitoring, logging and overall security information to an outside command center for global management purposes.

Kernel Firewall

Just as the MSP can perform the “side-band” scan of memory for security violations, the MSP is able to perform the same action against OS or Exec core memory in an attempt to ensure that the host computer system remains intact.

One current trend in rogue software is to attempt to modify the operating system or Exec system structures in order to gain control of the computer. Directing the side-band processing of MSP Security Controller 7 at the OS or Exec memory footprint itself can offer a very powerful “Kernel Monitor”. If key components of the operating system or Exec are changed or requested for change without proper process context, MSP Security Controller 7 can block the requests and prevent further access. Consequently, the MSP can operate as a hardware-managed Kernel Firewall.

Memory Latency Timing

Adjustment of the memory access timing is critical to providing increased processing bandwidth and security operations on the MSP. This adjustment will allow enough time to monitor, inject, transform or block data as it flows through the memory stream. As discussed above, the exemplary MSP2 device makes use of the fact that new serial communication memory architectures (FBDIMM) have increased the time for memory accesses due to the inherent latency of constructing parallel memory data from a serial stream of data. However, relaxation of the memory constraints (increased memory latency timing) of existing memory architectures will also provide for adequate memory access timing to support the operations of the MSP. The important is that the concept of “timing relaxation” is by design; if a host's memory controller (regardless of location) is designed to relax the data retrieval rate, increased processing and security functionality can be achieved by the invention.

We claim:

1. A computing system comprising:
a processor;
one or more memory modules;
a hardware-based security controller positioned between the processor and the memory modules;
a software isolation (ISO) module that is a kernel-level software component that monitors memory operations issued by a software application executed by the processor;
wherein the ISO module captures context and control information from the memory operations and communicates the information to the security controller, and
wherein the security controller applies one or more security operations to memory operations between the processor and the memory modules to ensure that data used by the processor are secure.

2. The computing system of claim 1, wherein the security controller comprises an application-specific integrated circuit disposed on a memory stick that is sized and includes an electrical interface to conform to a pluggable memory stick that may be inserted within a standard memory slot of the computing system.

3. The computing system of claim 1, wherein the security controller comprises:
a plurality of processing blades that operate as event engines, wherein each event engine is configurable to apply a respective security of operation to the memory operations; and
an embedded processor to program the event engines to detect different events within the memory operations that may indicate security threats to the computing system.

4. The computing system of claim 3,
wherein each of event engines is a configurable logic block capable of snooping the memory operations as data is normally communicated between the memory controller and the memory modules,
wherein each of the event engines is programmed to detect one or more events within the memory operations.

5. The computing system of claim 1, wherein the security controller accepts and processes the memory operations in real-time to apply one or more security operations on the memory operations as the operations flow to and from the memory modules.

6. The computing system of claim 1, wherein the security controller comprises a credential engine that is a configurable logic block that constructs, manages and stores credentials for verifying both users and software application.

7. The computing system of claim 1, wherein the security controller comprises an in-band communication unit that determines whether one or more of the memory operations is a legitimate memory access or a communication to program the security controller.

8. The computing system of claim 1, wherein the security controller comprises an off-board serial communication port that provides an alternate path for programming the security controller other than the memory operations.

9. The computing system of claim 1, wherein the security controller comprises a memory-latched control that provides a mechanism where the ISO module and the security controller can share information from a standard memory bus slot.

10. The computing system of claim 1,
wherein the memory modules utilize a serial communication interface having a latency time defined as a time period from when the memory modules receive one of the memory operations and provide a corresponding response, and
wherein the security controller applies the security operations to the memory operations during the latency period without substantially impacting a response time of the memory modules.

11. A method comprising the steps of:
executing a software module within a computing system to intercept a request from a software application to access data stored in a hardware memory module of the computing system;
relaying information from the software module to a hardware-based security integrated circuit embedded within a memory system of the computing system, wherein the information comprises context information for the software application, and wherein the security integrated circuit is positioned to access a memory bus between a memory controller and a module;
subsequent to relaying the information, monitoring a memory access request between a processor and the memory module with the hardware-based security integrated circuit;
determining within the hardware security integrated circuit, based on the context information, whether the monitored memory access request constitutes a security threat; and
performing the memory access request when it is determined that the request does not constitute a security threat.

12. The method of claim 11, wherein determining whether returning the requested data would constitute a security threat comprises determining whether the request is attempting to access data outside a memory range allocated to the software application.

13. The method of claim 12, wherein the memory request from the processor is initiated by an operating system.

14. The method of claim 11, wherein relaying the context information comprises relaying the context information using an in-band communication protocol that utilizes an existing hardware interface between the processor and a memory system of the computing system.

15. The method of claim 11,
wherein determining whether returning the memory access request constitute a security threat comprises executing a security algorithm within the hardware security integrated circuit, and
wherein the hardware security integrated circuit is formed as a component located on a removable memory module inserted within a standard memory slot of the computing system.

16. The method of claim 11,
wherein determining whether returning the memory access request constitute a security threat comprises executing a security algorithm within the hardware security integrated circuit, and
wherein the hardware security integrated circuit is formed as a component located on the memory controller of the computing system.

17. The method of claim 11, wherein determining whether returning the request constitutes a security threat comprises comparing an unauthorized code segment with the requested data.

18. The method of claim 11, wherein the determination occurs at full system speed of an existing hardware interface between the processor and a memory system of the computing system.

19. The method of claim 11, further comprising downloading virus-protection configuration information via an application software to the hardware security integrated circuit.

20. The method of claim 11, further comprising downloading rogue programmatic components via an application software to the hardware security integrated circuit.

21. The method of claim 11, wherein the method further comprises:
monitoring a plurality of memory access requests between the processor and the memory module with the hardware-based security integrated circuit; and
determining within the hardware-based security integrated circuit, based on the context information, whether a pattern of the plurality of memory access requests constitutes a security threat.

22. The method of claim 11, determining whether the monitored memory access request constitutes a security threat comprises determining whether the software application is a software application associated with the requested data stored in the hardware memory module.

23. An integrated memory stick that may be inserted within a standard memory slot of a computing system, the memory stick comprising:
a memory bus interface to receive memory access requests from a processor;
a data storage chip to store data; and
an application-specific integrated circuit (ASIC) to determine whether the requests constitute security threats and allow the performance of the request on the data storage chip when the request do not constitute security threats.

24. The memory module of claim 23, wherein the ASIC determines whether the requests constitute security threats by determining whether a process is attempting to access data outside a memory range in the data storage chip allocated to the process.

25. The memory module of claim 23,
wherein the ASIC receives process context information relayed to the ASIC by the memory bus interface from a security software module executing on the processor, wherein the process context information provides context information for the process as maintained by the operating system, and
wherein the ASIC determines whether the process is attempting to access data outside the memory range allocated to the process by determining whether the request is within the memory range allocated for the process indicated by the process context information.

26. The memory module of claim 23, wherein the ASIC receives the process context information using an in-band communication bus.

27. The memory module of claim 23, wherein the ASIC determines compares the requested data against an unauthorized code segment.

28. The memory module of claim 23, wherein the ASIC performs the determination at full system speed.

29. A computing system comprising:
a processor;
one or more memory modules;
a hardware-based security controller positioned between the processor and the memory modules;
a software isolation (ISO) module that is a kernel-level software component that monitors memory operations issued by a software application executed by the processor;
wherein the ISO module captures context and control information from the memory operations and communicates the information to the security controller, and
wherein the security controller applies one or more security operations to memory operations between the processor and the memory modules to ensure that instructions used by the processor are secure.

30. A memory controller comprising:
a standard memory controller of a computing system;
a memory bus interface to receive memory access requests from a processor;
a data storage chip to store data; and
a hardware security controller combined with an application-specific integrated circuit (ASIC) to determine whether the requests constitute security threats and allow the performance of the request on the data storage chip when the request do not constitute security threats.

31. The memory controller of claim 30, wherein the ASIC determines whether the requests constitute security threats by determining whether a process is attempting to access data outside a memory range in the data storage chip allocated to the process.

32. The memory controller of claim 30,
wherein the ASIC receives process context information relayed to the ASIC by the memory bus interface from a security software module executing on the processor, wherein the process context information provides context information for the process as maintained by the operating system, and
wherein the ASIC determines whether the process is attempting to access data outside the memory range allocated to the process by determining whether the request is within the memory range allocated for the process indicated by the process context information.

33. The memory controller of claim 30, wherein the ASIC receives the process context information using an in-band communication bus.

34. The memory controller of claim 30, wherein the ASIC determines compares the requested data against an unauthorized code segment.

35. The memory controller of claim 30, wherein the ASIC performs the determination at full system speed.
